(19) United States
(12) Patent Application Publication
(10) Pub. No.: US 2021/0154744 A1
(43) Pub. Date: May 27, 2021

(54) BUILD PLATFORM AND POWDER TRANSER SYSTEM FOR ADDITIVE MANUFACTURING

(71) Applicant: APPLIED MATERIALS, INC., Santa Clara, CA (US)

(72) Inventor: David Masayuki Ishikawa, Mountain View, CA (US)

(21) Appl. No.: 17/051,408

(22) PCT Filed: Apr. 30, 2019
(86) PCT No.: PCT/US2019/030030

§ 371 Date: Oct. 28, 2020

Related U.S. Application Data
(60) Provisional application No. 62/664,861, filed on Apr. 30, 2018.

(51) Int. Cl. B22F 12/33; B22F 10/28; B22F 12/00; B22F 12/52; B22F 12/70; B33Y 30/00; B33Y 50/02; B22F 12/90

(52) U.S. Cl. CPC B22F 12/33; B22F 10/28; B22F 12/38; B22F 12/52; B22F 12/90; B22F 12/224; B33Y 30/00; B33Y 50/02; B22F 12/70

(57) ABSTRACT

An additive manufacturing system includes a factory interface chamber, a load lock chamber, a first valve to fluidically seal the factory interface chamber from the load lock chamber, an additive manufacturing chamber including a dispensing system to deliver a plurality of layers of a powder to a build platform and an energy source to apply energy to the powder dispensed on the top surface of the build platform, at least a second valve to fluidically seal the load lock chamber from the additive manufacturing chamber, and a plurality of supports and actuators that provide a transport tool to carry the build platform from the factory interface unit, through the load lock chamber, to the additive manufacturing chamber, and back to the factory interface chamber.

### CROSS-REFERENCE TO RELATED APPLICATIONS

This application claims priority to U.S. Provisional Application Ser. No. 62/664,861, filed on Apr. 30, 2018.

### TECHNICAL FIELD

This specification relates to additive manufacturing, also known as 3D printing.

### BACKGROUND

Additive manufacturing (AM), also known as solid freeform fabrication or 3D printing, refers to a manufacturing process where three-dimensional objects are built up from successive dispensing of raw material (e.g., powders, liquids, suspensions, or molten solids) into two-dimensional layers. In contrast, traditional machining techniques involve subtractive processes in which objects are cut out from a stock material (e.g., a block of wood, plastic or metal).

A variety of additive processes can be used in additive manufacturing. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g., stereolithography (SLA). These processes can differ in the way layers are formed to create the finished objects and in the materials that are compatible for use in the processes.

Conventional systems use an energy source for sintering or melting a powdered material. Once all the selected locations on the first layer are sintered or melted and then re-solidified, a new layer of powdered material is deposited on top of the completed layer, and the process is repeated layer by layer until the desired object is produced.

### SUMMARY

In one aspect, an additive manufacturing system includes a factory interface chamber, a load lock chamber, a first valve to fluidically seal the factory interface chamber from the load lock chamber, an additive manufacturing chamber including a dispensing system to deliver a plurality of layers of a powder to a build platform and an energy source to apply energy to the powder dispensed on the top surface of the build platform, at least a second valve to fluidically seal the load lock chamber from the additive manufacturing chamber, and a plurality of supports and actuators that provide a transport tool to carry the build platform from the factory interface unit, through the load lock chamber, to the additive manufacturing chamber, and back to the factory interface chamber.

Implementations may include one or more of the following features.

The transport tool may include a transport track to carry the build platform.

A transfer chamber may be positioned between the load lock chamber and the additive manufacturing chamber. The transport tool may be configured to carry the build platform from the factory interface unit, through the load lock chamber and the transfer chamber, to the additive manufacturing chamber, and back to the factory interface chamber. The second valve may fluidically seal the load lock chamber from the transfer chamber, and a third valve may fluidically seal the additive manufacturing chamber from the transfer chamber. A plurality of processing chambers may be coupled to the transfer chamber, the plurality of processing chambers including the additive manufacturing chamber. The plurality of processing chambers may include a plurality of additive manufacturing chambers. The transfer chamber may include a rotatable support to selectively direct a build platform to one of the plurality of processing chambers.

The factory interface chamber may include a storage area configured to hold a plurality of build platforms. The transport tool may be configured to retrieve a build platform from the storage area. A gas supply may be coupled to the transfer chamber to maintain the transfer chamber at a partial pressure of oxygen less than about 0.01 atmosphere. The gas supply is configured to maintain the transfer chamber at a pressure of about 1 atmosphere. A gas supply may be coupled to the additive manufacturing chamber to maintain the transfer chamber at a partial pressure of oxygen less than about 0.01 atmosphere. The gas supply may be configured to maintain the additive manufacturing chamber at a pressure of about 1 atmosphere.

In another aspect, an additive manufacturing apparatus for forming an object includes a build platform to support the object being formed, a dispensing system to deliver a plurality of layers of a powder to the build platform, a housing to enclose the build platform and dispensing system in a sealed chamber, an energy source to apply energy to the powder dispensed on the top surface of the build platform, and a powder transfer system to deliver powder to the dispensing system. The powder transfer system includes a mechanical interface to engage a receptacle positioned exterior to the housing, an interior volume to receive powder from the receptacle, a valve to fluidically seal the interior volume from the chamber containing the dispensing system, and a vacuum source to purge powder in the interior volume of gas before the powder is transferred to the dispensing system.

Implementations may include one or more of the following features.

The mechanical interface may be configured to form a sealed connection to an interior volume of the receptacle that contains a supply of the powder. The mechanical interface may include a front operated user port. The dispensing system may include a hopper to hold powder, and the dispensing system and hopper may be horizontally movable relative to the build platform. The powder transfer system may include a reservoir coupled to the mechanical interface to receive powder from a canister engaged to the mechanical interface, and the valve may be positioned between the mechanical interface and the reservoir. A second valve may control delivery of powder from the reservoir to the hopper. The reservoir and second valve may be stationary, and the hopper may be movable to a position beneath the second valve.

Advantages of the foregoing may include, but are not limited to, the following. Contamination of powder, e.g., by oxygen, can be reduced, thereby improving part quality and yield. A transfer chamber and the a build chambers, e.g., a selective laser melting chamber, may be maintained at atmospheric pressure to avoid the cost and complexity of building a fully vacuum compatible system. Build plates may be reused. Different powders can be delivered in different chambers.

The details of one or more implementations of the subject matter described in this specification are set forth in the accompanying drawings and the description below. Other potential features, aspects, and advantages will become apparent from the description, the drawings, and the claims.

### BRIEF DESCRIPTION OF THE DRAWINGS

FIG. 1 is a schematic top view of an additive manufacturing system.

FIG. 2 is a schematic side view of the additive manufacturing system of FIG. 1.

FIG. 3 is a schematic cross-sectional view of an example additive manufacturing chamber from the additive manufacturing system.

FIG. 4A is a schematic side view of an example of a printhead for an example additive manufacturing apparatus.

FIG. 4B is a schematic top view of the printhead of FIG. 4A.

FIG. 5 is a schematic side view of a canister loaded into an interface.

Like reference numbers and designations in the various drawings indicate like elements.

### DETAILED DESCRIPTION

Additive manufacturing (AM) apparatuses can form an object by dispensing and fusing successive layers of a powder on a build platform. This powder, particularly in the case of metal powders, can be very expensive. If powder is exposed to the air, e.g., to oxygen, it can become contaminated. Oxide sensitive processes can be protected from contamination by using a glove box or equivalent inert gas containment in order to try and minimize oxygen. However, in a commercially scaled 3D printing application, it may be necessary to move build platforms into and out of the printing system, and the glove-box type approach may not be compatible with this functionality. Moreover, even one percent oxygen volume remains too high for minimizing oxide formation. The primary source of oxygen in the process chamber during metal printing is oxygen released from the powder during chamber evacuation (in the case of 3DS) or purging.

To this end, a load lock can be used to minimize oxygen migration into the processing chamber in an additive manufacturing platform. A separate chamber can be used for powder evacuation and purge. In principal, removing the large volume of powder from the SLM processing chamber eliminates the addition of oxygen and moisture to the processing chamber. In addition, the additive manufacturing system includes a build plate storage and conveyance design.

### Additive Manufacturing System

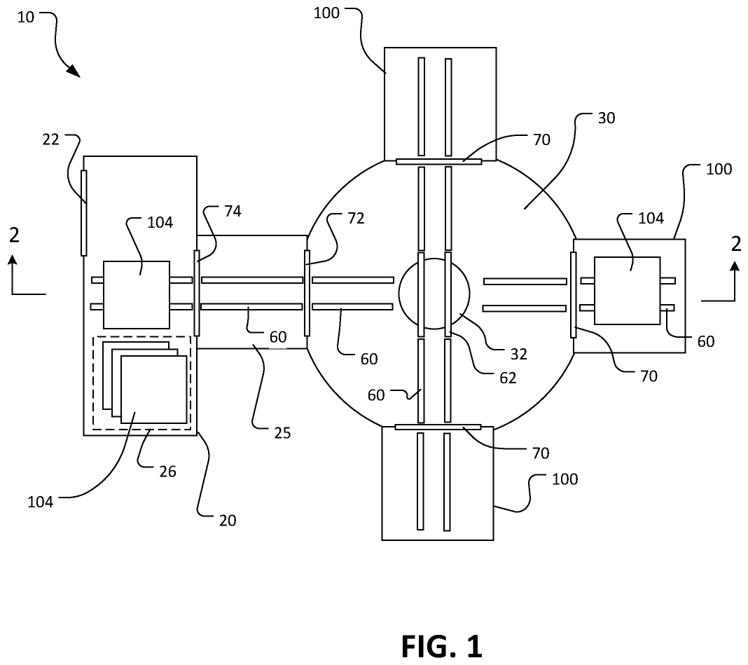

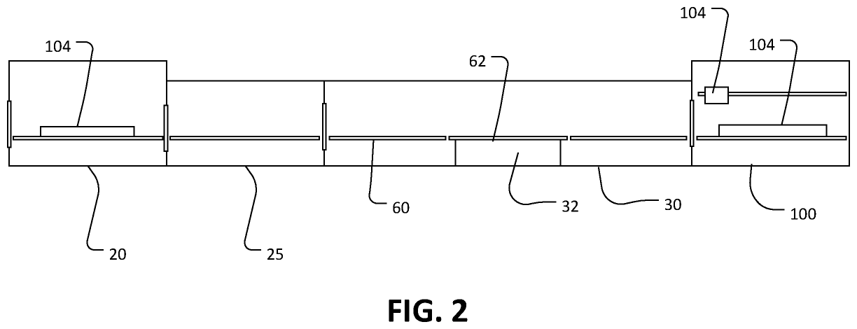

FIG. 1 illustrates a schematic top view of an additive manufacturing system 10, and FIG. 2 illustrates a schematic side view of the additive manufacturing system 10.

The system 10 includes a factory interface 20, a vacuum load lock 25, a transfer chamber 30, and one or more additive manufacturing chambers 100. The system 10 also includes a track tool designed to convey build plates 104 from a factory interface, through a vacuum load lock, and into a transfer chamber that services one or more additive manufacturing chamber, and back to the factory interface.

The factory interface 20 includes a port 22 through which the build plates 104 can be transferred in or out. For example, fresh build plates can be inserted, and build plates having objects fabricated thereon can be removed from the factory interface 20. The factory interface can also include a storage area 26 in which one or more build plates 104 may be temporarily stored, e.g., until needed for use for fabrication of an object in an additive manufacturing chamber 100.

The load lock 25 separates the transfer chamber 30, which is a low-oxygen environment, from the factory interface 20, which is exposed to air when the port 22 is opened. Build plates 104 can be fed into the load lock 25 one at a time, and then transferred from the load lock 25 into the transfer chamber 30 one at a time.

The transfer chamber 30 and the additive manufacturing chambers 100 may be maintained at atmospheric pressure (but at less than 1% oxygen) to avoid the cost and complexity of building a fully vacuum compatible system.

The track tool can include a set of tracks 60, e.g., rails along which the build plate 104 can move under influence of an actuator, in the factory interface 20, load lock 25, transfer chamber 30 and additive manufacturing chamber 100, configured to convey a build plate 104. To accommodate multiple processing chambers, the track tool can include a rotatable base 32 that supports one segment 62 of the track 60. This permits the segment 62 to be rotated so that the build plate can be transferred to the track leading to the appropriate chamber.

Each additive manufacturing chamber 100 can be fluidically sealable from the transfer chamber 30 by a valve 70, e.g., slit valve. Similarly, the transfer chamber 30 can be fluidically sealable from the load lock 25 by a valve 72, e.g., slit valve, and the load lock 25 can be fluidically sealable from the factory interface 20 by a valve 74, e.g., slit valve.

Each additive manufacturing chamber 100 attached to the transfer chamber 30 is serviced by a powder delivery system. Powders may be delivered using gravity or fluidized and delivery using argon or nitrogen. The powder will be supplied to the powder delivery system either under vacuum or may be purged and evacuated in a volume separate from the processing chambers. In this way, any moisture or gas contamination trapped between the powders may be evacuated without contaminating the SLM process chamber.

Although FIG. 1 illustrates three additive manufacturing chambers 100, other types of processing chambers could be located off the transfer chamber 30, e.g., electron beam manufacturing (EBM) chambers, deposition chambers, etching chambers, etc.

Note that in a single-chamber architecture, the transfer chamber 30 and the load lock 25 may be one volume.

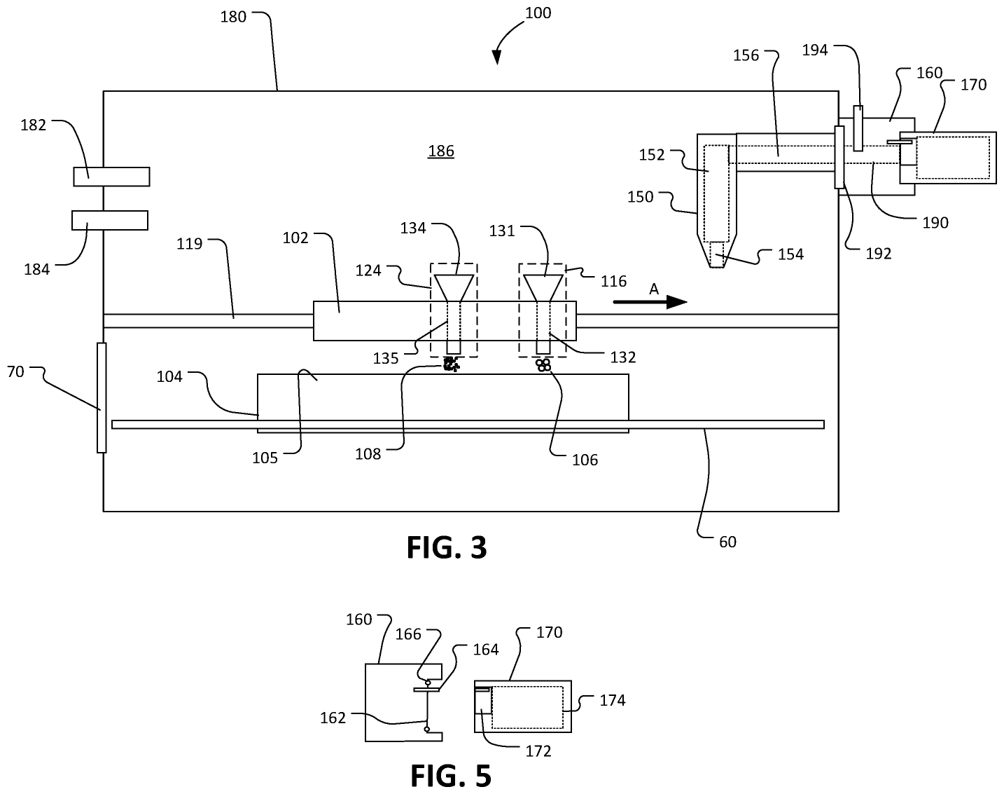

FIG. 3 illustrates a schematic side view of an example additive manufacturing (AM) chamber 100 that includes a printhead 102 secured to a printhead support 119, and a build platform 104 (e.g., a build stage) supported on the track 60. The printhead 102 dispenses a powder 106 and, optionally, fuses the powder 106 dispensed on the platform 104. Optionally, as described below, the printhead 102 can also dispense and/or fuse a second powder 108 on the platform 104.

The printhead 102 and a build platform 104 can both be enclosed in a housing 180 that forms a sealed chamber 186, e.g., a vacuum chamber, that provides a controlled operating environment. The chamber 180 can include an inlet 182 coupled to a gas source, and an outlet 184 coupled to an exhaust system, e.g., a pump. The gas source can supply an inert gas, e.g., Ar, or a gas that does not react with the powder at the temperatures reached during melting, e.g., N₂. This permits the pressure and oxygen content of the interior of the housing 180 to be controlled. For example, oxygen gas can be maintained below 50 ppm when dealing with Ti powder particles. As noted above, in some implementations, the chamber 186 is maintained at atmospheric pressure, but at low oxygen content (e.g., less than 1%).

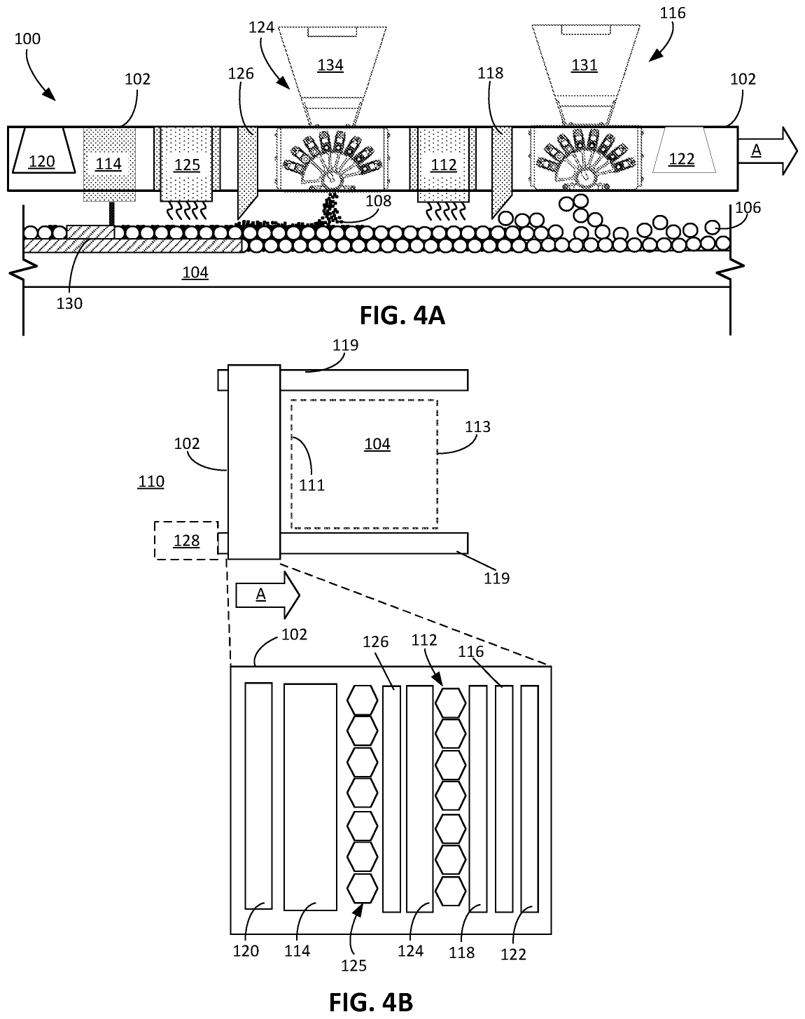

Referring to FIGS. 3 and 4B, the printhead 102 is configured to traverse the platform 104. For example, the apparatus 100 can include a support, e.g., a linear rail or pair of linear rails 119, along which the printhead can be moved by a linear actuator and/or motor. This permits the printhead 102 to move across the platform 104 along a first horizontal axis. In some implementations, the printhead 102 can move along a second horizontal axis perpendicular to the first axis.

The printhead 102 can also be movable along a vertical axis. In particular, the printhead 102 can be lifted by an amount equal to the thickness of the deposited layer of powder. This can maintain a constant height difference between the dispenser on the printhead and the top of the powder on the platform 104. A drive mechanism, e.g., a piston or linear actuator, can be connected to the printhead or support holding the printhead to control the height of the printhead. Alternatively, the printhead 102 can be held in a fixed vertical position, and the platform 104 can be lowered after each layer is deposited.

Referring to FIGS. 3, and 4A, the printhead 102 includes at least a first dispensing system 116 to selectively dispense powder 106 on the build platform 104. Referring to FIGS. 3 and 4A, the first dispensing system 116 includes a hopper 131 to receive the powder 106. The powder 106 can travel through a channel 136 having a controllable aperture, e.g., a valve, that controls whether the powder is dispensed onto the platform 104.

Returning to FIGS. 4A and 4B, the apparatus 100 also includes an energy source 114 to selectively add energy to the layer of powder on the build platform 104. The energy source 114 can be incorporated into the printhead 102 (as shown in FIGS. 4A and 4B), be mounted on a support that holds the printhead, or be mounted separately, e.g., on a separate support that is independently movable relative to the printhead 102, or on a frame supporting the build platform 104 or on a chamber wall that surrounds the build platform 104.

In some implementations, the energy source 114 can include a scanning laser that generates a beam of focused energy that increases a temperature of a small area of the layer of the powder. In some cases, the energy source 114 can include an ion beam or an electron beam. The energy source 114 can fuse the powder by using, for example, a sintering process, a melting process, or other process to cause the powder to form a solid mass of material. The energy source 114 can be positioned on the printhead 102 such that, as the printhead 102 advances in a forward direction, the energy source can selectively heat regions of powder dispensed by the dispensing system 116.

Optionally, the apparatus can include a heat source 112 to direct heat to raise the temperature of the deposited powder. The heat source 112 can heat the deposited powder to a temperature that is below its sintering or melting temperature. The heat source 112 can be, for example, a heat lamp array. The energy source 114 can be incorporated into the printhead 102, be mounted on a support that holds the printhead, or be mounted separately, e.g., on a separate support that is independently movable relative to the printhead 102, or on a frame supporting the build platform 104 or on a chamber wall that surrounds the build platform 104. The heat source 112 can be located, relative to the forward moving direction of the printhead 102, behind the first dispensing system 116. As the printhead 102 moves in the forward direction, the heat source 112 moves across the area where the first dispensing system 116 was previously located.

Optionally, the printhead 102 can also include a first spreader 118, e.g., a roller or blade, that cooperates with first the dispensing system 116 to compact and spread powder dispensed by the dispensing system 116. The spreader 118 can provide the layer with a substantially uniform thickness. In some cases, the first spreader 118 can press on the layer of powder to compact the powder.

The printhead 102 can also optionally include a first sensing system 120 and/or a second sensing system 122 to detect properties of the apparatus 100 as well as powder dispensed by the dispensing system 116.

In some implementations, the printhead 102 includes a second dispensing system 124 to dispense the second powder 108. The second dispensing system 116, if present, can be constructed similarly with a hopper 134 and channel 135. A second spreader 126 can operate with the second dispensing system 124 to spread and compact the second powder 108.

The first powder particles 106 can have a larger mean diameter than the second particle particles 108, e.g., by a factor of two or more. When the second powder particles 108 are dispensed on a layer of the first powder particles 106, the second powder particles 108 infiltrate the layer of first powder particles 106 to fill voids between the first powder particles 106. The second powder particles 108, being smaller than the first powder particles 106, can achieve a higher resolution, higher pre-sintering density, and/or a higher compaction rate.

Alternatively or in addition, if the apparatus 100 includes two types of powders, the first powder particles 106 can have a different sintering temperature than the second powder particles. For example, the first powder can have a lower sintering temperature than the second powder. In such implementations, the energy source 114 can be used to heat the entire layer of powder to a temperature such that the first particles fuse but the second powder does not fuse.

In implementations when multiples types of powders are used, the first and second dispensing systems 116, 124 can deliver the first and the second powder particles 106, 108 each into different selected areas, depending on the resolution requirement of the portion of the object to be formed.

Materials for the powder include metals, such as, for example, steel, aluminum, cobalt, chrome, and titanium, alloy mixtures, ceramics, composites, and green sand. In implementations with two different types of powders, in some cases, the first and second powder particles 106, 108 can be formed of different materials, while, in other cases, the first and second powder particles 106, 108 have the same material composition. In an example in which the apparatus 100 is operated to form a metal object and dispenses two types of powder, the first and second powder particles 106, 108 can have compositions that combine to form a metal alloy or intermetallic material.

The processing conditions for additive manufacturing of metals and ceramics are significantly different than those for plastics. For example, in general, metals and ceramics require significantly higher processing temperatures. Thus 3D printing techniques for plastic may not be applicable to metal or ceramic processing and equipment may not be equivalent. However, some techniques described here could be applicable to polymer powders, e.g. nylon, ABS, polyetheretherketone (PEEK), polyetherketoneketone (PEKK) and polystyrene.

If the apparatus 100 dispenses two different types of powders having different sintering temperatures, the first and second heat sources 112, 125 can have different temperature or heating set points. For example, if the first powder 106 can be sintered at a lower temperature than the second powder 108, the first heat source 112 may have a lower temperature set point than the second heat source 125.

Referring to FIGS. 3 and 5, after the dispensing system 116 dispenses one or more layers of powder, the hopper 131 can eventually run out of powder. In this case, the hopper 131 may need to be recharged. The printhead 102 can be moved to position the hopper 131 below a recharging dispenser 150. The recharging dispenser 150 includes a reservoir 152 to hold powder, and controllable nozzle 154 to controllably deliver powder from the reservoir 152 by gravity feed into the hopper 131 of the powder dispenser 116.

A mechanical interface 160 that provides a front operated user port 160 is coupled to the reservoir 152 by a passage 156 through which powder can flow, e.g., by gravity, or be directed, e.g., by an augur system. The user port 160 is accessible from the outside of the housing 180 so that an operator can place a canister 170 into the user port 160.

The user port 160 is configured to receive a canister 170 that holds new or recycled powder in an internal volume 174. The canister 170 can include a valve 172, e.g., a ball valve, that is biased into a shut position to isolate the internal volume 174 of the canister from the outside environment.

The front operated user port 160 includes a mounting plate 162 configured to hold the canister 170. The user port 160 also includes a projection 164, e.g., extending from the mounting plate 162. The projection 164 can be a bayonet feature. The projection 164 is configured to engage the valve 172 when the canister is mated to the mounting plate 162 so as to open the valve 172. The combination of the biased valve 172 and projection 164 helps prevent the valve from opening on the user port 160 unless it is connected to the mounting plate 162. In addition, an O-ring 166 can form a seal between the user port 160 and the canister 170 when the canister is mated to the mounting plate 162. Both of these reduce the likelihood of contamination of the powder in the internal volume 174.

The interface 160 can include an interior volume 190 into which the powder can flow from the canister 170. The volume 190 can be fluidically sealed from the reservoir 152 and passage 156 by a valve 192. In addition, the volume 190 can include a port 194 that can be coupled to a vacuum source to purge and evacuate any gas from the powder in the volume 190. This permits the powder to be purged before it enters the additive manufacturing chamber, and thus reduces the risk of oxygen contamination.

Although shown on the side of the housing 180, the front operated user port could be on the top of the housing 180, and the canister can be oriented with the opening and valve on the bottom such that powder can flow by gravity into the reservoir 152.

Although unillustrated, if the printhead 102 includes a second powder dispenser 124, the apparatus 100 can include a second recharging dispenser and a second mechanical interface for receiving a canister with the second powder, otherwise constructed and operated as described above.

A controller 128 controls the operations of the apparatus 100, including the operations of the printhead 102 and its subsystems, such as the heat source 112, the energy source 114, and the first dispensing system 116. The controller 128 can also control, if present, the first spreader 118, the first sensing system 120, the second sensing system 122, the second dispensing system 124, and the second spreader 126. The controller 128 can also receive signals from, for example, user input on a user interface of the apparatus or sensing signals from sensors of the apparatus 100. The controller 128 can operate the dispensing system 116 to dispense the powder 106 and can operate the energy source 114 and the heat source 112 to fuse the powder 106 to form a workpiece 130 that becomes the object to be formed.

The controller 128 can include a computer aided design (CAD) system that receives and/or generates CAD data. The CAD data is indicative of the object to be formed, and, as described herein, can be used to determine properties of the structures formed during additive manufacturing processes. Based on the CAD data, the controller 128 can generate instructions usable by each of the systems operable with the controller 128, for example, to dispense the powder 106, to fuse the powder 106, to move various systems of the apparatus 100, and to sense properties of the systems, powder, and/or the workpiece 130. In some implementations, the controller 128 can control the first and second dispensing systems 116, 124 to selectively deliver the first and the second powder particles 106, 108 to different regions.

The controller 128, for example, can transmit control signals to drive mechanisms that move various components of the apparatus. In some implementations, the drive mechanisms can cause translation and/or rotation of these different systems, including dispensers, rollers, support plates, energy sources, heat sources, sensing systems, sensors, dispenser assemblies, dispensers, and other components of the apparatus 100. Each of the drive mechanisms can include one or more actuators, linkages, and other mechanical or electromechanical parts to enable movement of the components of the apparatus.

### CONCLUSION

The controller and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made.

Accordingly, other implementations are within the scope of the claims.

1. An additive manufacturing system, comprising:
a factory interface chamber;
a load lock chamber;
a first valve to fluidically seal the factory interface chamber from the load lock chamber;
an additive manufacturing chamber including a dispensing system to deliver a plurality of layers of a powder to a build platform, and an energy source to apply energy to the powder dispensed on the top surface of the build platform;
at least a second valve to fluidically seal the load lock chamber from the additive manufacturing chamber; and
a plurality of supports and actuators that provide a transport tool to carry the build platform from the factory interface unit, through the load lock chamber, to the additive manufacturing chamber, and back to the factory interface chamber.

2. The system of claim 1, wherein the transport tool comprises a transport track to carry the build platform.

3. The system of claim 1, comprising a transfer chamber between the load lock chamber and the additive manufacturing chamber, and the transport tool is configure to carry the build platform from the factory interface unit, through the load lock chamber and the transfer chamber, to the additive manufacturing chamber, and back to the factory interface chamber.

4. The system of claim 3, wherein the second valve fluidically seals the load lock chamber from the transfer chamber, and comprising a third valve to fluidically seal the additive manufacturing chamber from the transfer chamber.

5. The system of claim 3, comprising a plurality of processing chambers coupled to the transfer chamber, the plurality of processing chambers including the additive manufacturing chamber.

6. The system of claim 5, wherein the plurality of processing chambers include a plurality of additive manufacturing chambers.

7. The system of claim 5, wherein the transfer chamber includes a rotatable support to selectively direct a build platform to one of the plurality of processing chambers.

8. The system of claim 1, wherein the factory interface chamber includes a storage area configured to hold a plurality of build platforms, and the transport tool is configure to retrieve a build platform from the storage area.

9. The system of claim 1, comprising a gas supply coupled to the transfer chamber to maintain the transfer chamber at a partial pressure of oxygen less than about 0.01 atmosphere.

10. The system of claim 9, wherein the gas supply is configured to maintain the transfer chamber at a pressure of about 1 atmosphere.

11. The system of claim 1, comprising a gas supply coupled to the additive manufacturing chamber to maintain the additive manufacturing chamber at a partial pressure of oxygen less than about 0.01 atmosphere.

12. The system of claim 11, wherein the gas supply is configured to maintain the additive manufacturing chamber at a pressure of about 1 atmosphere.

13. An additive manufacturing system, comprising:
a build chamber;
a valve to fluidically seal the build chamber;
a support to hold a build plate in the build chamber;
an actuator to carry the build plate through the valve and onto the support;
a dispensing system to deliver a plurality of layers of a powder to the build plate in the build chamber; and
an energy source to apply energy to the powder dispensed on the top surface of the build plate in the build chamber.

14. The system of claim 13, comprising a transport track to carry the build platform.

15. The system of claim 13, wherein the valve comprises a slit valve.

16. An additive manufacturing apparatus for forming an object, the additive manufacturing apparatus comprising:
a build platform to support the object being formed;
a dispensing system to deliver a plurality of layers of a powder to the build platform,
a housing to enclose the build platform and dispensing system in a sealed chamber;
an energy source to apply energy to the powder dispensed on the top surface of the build platform; and
a powder transfer system to deliver powder to the dispensing system, the powder transfer system including a mechanical interface to engage a receptacle positioned exterior to the housing, an interior volume to receive powder from the receptacle, a valve to fluidically seal the interior volume from the chamber containing the dispensing system, and a vacuum source to purge powder in the interior volume of gas before the powder is transferred to the dispensing system.

17. The apparatus of claim 15, wherein the dispensing system comprises a hopper to hold powder, and wherein the dispensing system and hopper are horizontally movable relative to the build platform.

18. The apparatus of claim 17, wherein the powder transfer system comprises a reservoir coupled to the mechanical interface to receive powder from a canister engaged to the mechanical interface, and the valve is positioned between the mechanical interface and the reservoir.

19. The apparatus of claim 18, further comprising a second valve to control delivery of powder from the reservoir to the hopper.

20. The apparatus of claim 19, wherein the reservoir and second valve are stationary, and the hopper is movable to a position beneath the second valve.
